(19) United States
(12) Patent Application Publication
(10) Pub. No.: US 2015/0280996 A1
(43) Pub. Date: Oct. 1, 2015

(54) CLOUD TOPOLOGY VISUALIZATIONS

(71) Applicant: Hewlett-Packard Development Company, L.P., Houston, TX (US)

(72) Inventors: Steve Berube, Sandown, NH (US); Carlos Bonilla, Fort Collins, CO (US); Stephen B. Gest, Fort Collins, CO (US)

(73) Assignee: Hewlett-Packard Development Company, L.P., Houston, TX (US)

(21) Appl. No.: 14/242,230

(22) Filed: Apr. 1, 2014

(51) Int. Cl. H04L 12/24; H04L 12/26

(52) U.S. Cl. CPC H04L 41/12; H04L 43/045

(57) ABSTRACT

Example implementations relate to cloud topology visualizations. In example implementations, node models may be received from a plurality of model repositories. The received node models may correspond to nodes in the same cloud topology. Each of the plurality of model repositories may be associated with a respective model-specific format and a respective cloud provider. Each of the received node models may be in a model-specific format associated with the respective model repository from which the node model was received. The respective model-specific format of each received node model may be translated into a generic format. The generic-format node models may be sent to a topology visualizer. The topology visualizer may generate, based on the generic-format node models, a visualization of the cloud topology.

### BACKGROUND

Cloud computing systems may include different types of nodes, such as servers and load balancers. A cloud provider may receive user specifications for cloud resources, and may provision and deploy resources accordingly. A cloud topology visualization may show relationships between various nodes of a user's cloud instance.

### BRIEF DESCRIPTION OF THE DRAWINGS

The following detailed description references the drawings, wherein:

FIG. 1 is an example cloud topology visualization;

FIG. 2 is a block diagram of an example device that includes a machine-readable storage medium encoded with instructions to enable collection of data for a cloud topology visualization;

FIG. 3 is a block diagram of an example device that includes a machine-readable storage medium encoded with instructions to enable filtering of data for generating a cloud topology visualization;

FIG. 4 is a block diagram of an example device that includes a machine-readable storage medium encoded with instructions to send a temporary internal data structure to a topology visualizer;

FIG. 5 is a block diagram of an example device that includes a machine-readable storage medium encoded with instructions to generate a cloud topology visualization;

FIG. 6 is a block diagram of an example device that includes a machine-readable storage medium encoded with instructions to generate a display of options for a cloud topology visualization;

FIG. 7 is a flowchart of an example method for collecting data for a cloud topology visualization;

FIG. 8 is a flowchart of an example method for filtering data for generating a cloud topology visualization;

FIG. 9 is a flowchart of an example method for generating a cloud topology visualization that includes options of actions; and

FIG. 10 is an example system for generating a cloud topology visualization that includes options of actions.

### DETAILED DESCRIPTION

Cloud computing systems may include different types of nodes and/or multiple nodes of a particular type. Some cloud instances may include nodes provided by multiple cloud providers. For example, a cloud instance may include a group of servers provided by a first cloud provider and a group of servers provided by a second (i.e., different) cloud provider. Different cloud providers may use different languages/formats to model the same node type. Cloud topology visualizers may be used to generate cloud topology visualizations, but may be hard-coded to support a certain language/format and thus may not recognize node models in a different language/format.

In light of the above, the present disclosure enables visualizations of cloud topologies having nodes provided by multiple cloud providers. Generic node models may be generated based on cloud provider-specific models to allow extensibility across various cloud providers and cloud deployment models for cloud topology visualizations. Thus, users may be able to better understand connections and dependencies between nodes provided by different cloud providers in the same cloud instance, and may be able to more easily troubleshoot failures.

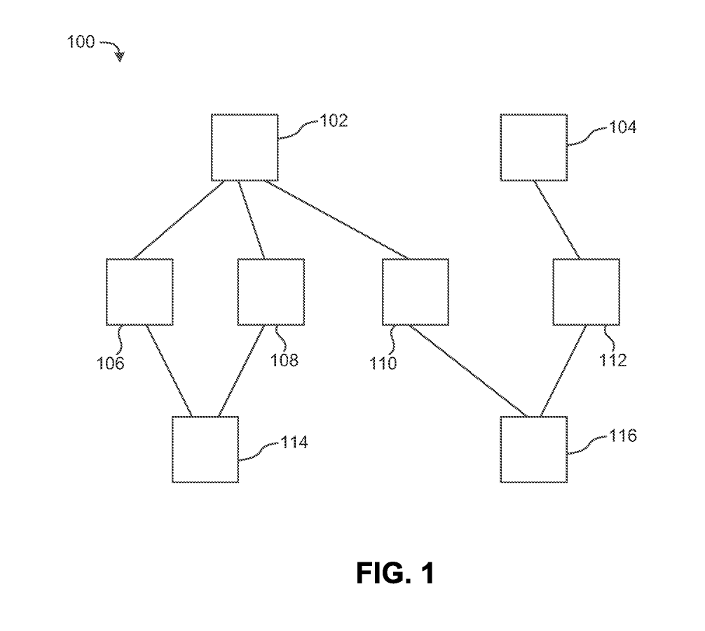

Referring now to the drawings, FIG. 1 is an example cloud topology visualization 100. A cloud topology visualization may include representations of nodes in a cloud topology and indications of relationships between nodes. Examples of relationships between nodes may include hierarchy, parent-child, containment (e.g., one node contains another node), and communication (e.g., transfer of data between nodes). In visualization 100 of FIG. 1, boxes may represent nodes and lines between boxes may represent relationships between nodes.

For example, box 102 may represent a server group, and boxes 106, 108, and 110 may represent servers. Lines between box 102 and each of boxes 106, 108, and 110 may represent a containment relationship between the server group represented by box 102 and each of the servers represented by boxes 106, 108, 110 (i.e., the server group contains the servers). Boxes 114 and 116 in visualization 100 may represent virtual networks. Lines between box 114 and each of boxes 106 and 108 may represent a communication relationship between the virtual network represented by box 114 and each of the servers represented by boxes 106 and 108 (e.g., the servers may be connected to the virtual network and the servers may send or receive data via the virtual network). Similarly, the line between box 116 and box 110 may represent a communication relationship between the virtual network represented by box 116 and the server represented by box 110. Box 104 may represent an application and box 112 may represent a server on which the application represented by box 104 is hosted. The line between box 104 and box 112 may represent the client-server relationship between the application and server. The line between box 116 and box 112 may represent a communication relationship between the virtual network represented by box 116 and the server represented by box 112.

In some implementations, boxes in visualization 100 may include icons, color schemes, shading patterns, and/or labels indicating what type of node is represented. Boxes in visualization 100 may include symbols indicating a status (e.g., active/idle, successfully/unsuccessfully provisioned) of a respective node. In some implementations, lines between boxes in visualization 100 may have arrows to indicate directionality of a relationship and/or directionality of communication. Lines between boxes in visualization 100 may have labels indicating types of relationships represented by the lines.

Different nodes represented in a visualization may be provided by different cloud providers. For example, in visualization 100, boxes may include icons, color schemes, shading patterns, and/or labels indicating the cloud provider of a respective node. In some implementations, cloud providers may be represented by boxes in visualization 100. For example, boxes 102 and 104 in visualization 100 may represent a first cloud provider and a second provider, respectively. The first cloud provider may provide servers represented by boxes 106, 108, and 110, and the second cloud provider may provide a server represented by box 112. Servers represented by boxes 106 and 108 may be connected to a virtual network represented by box 114, and servers represented by boxes 110 and 112 may be connected to a virtual network represented by box 116.

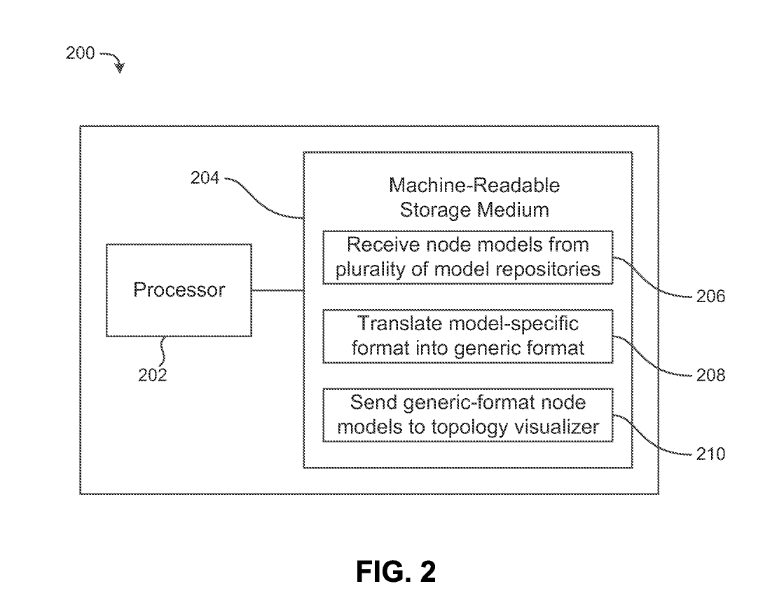

FIG. 2 is a block diagram of an example device 200 that includes a machine-readable storage medium encoded with instructions to enable collection of data for a cloud topology visualization. As used herein, the terms “include”, “have”, and “comprise” are interchangeable and should be understood to have the same meaning, In some implementations, device 200 may operate as and/or be part of a server. In FIG. 2, device 200 includes processor 202 and machine-readable storage medium 204.

Processor 202 may include a central processing unit (CPU), microprocessor (e.g., semiconductor-based microprocessor), and/or other hardware device suitable for retrieval and/or execution of instructions stored in machine-readable storage medium 204. Processor 202 may fetch, decode, and/or execute instructions 206, 208, and 210 to enable collection of data for a cloud topology visualization, as described below. As an alternative or in addition to retrieving and/or executing instructions, processor 202 may include an electronic circuit comprising a number of electronic components for performing the functionality of instructions 206, 208, and/or 210.

Machine-readable storage medium 204 may be any suitable electronic, magnetic, optical, or other physical storage device that contains or stores executable instructions. Thus, machine-readable storage medium 204 may include, for example, a random-access memory (RAM), an Electrically Erasable Programmable Read-Only Memory (EEPROM), a storage device, an optical disc, and the like. In some implementations, machine-readable storage medium 204 may include a non-transitory storage medium, where the term “non-transitory” does not encompass transitory propagating signals. As described in detail below, machine-readable storage medium 204 may be encoded with a set of executable instructions 206, 208, and 210.

Instructions 206 may be executable to receive node models from a plurality of model repositories. The received node models may correspond to nodes in the same cloud topology. Each of the plurality of model repositories may be associated with a respective model-specific format and a respective cloud provider. Each of the received node models may be in a model-specific format associated with the respective model repository from which the node model was received. As used herein, the term “model-specific format”, as used with respect to model repositories or node models, should be understood to refer to a language and/or format that is specific to a cloud provider that provides the nodes that are modeled. Different cloud providers may model the same type of node in different languages/formats. Each cloud provider may maintain its own model repository with models of various types of nodes that the cloud provider may provide. The same node type (e.g., server) may be in different model-specific formats in different model repositories maintained by different cloud providers. For example, a node model of a server node may be in a first model-specific format when the server is provided by a first cloud provider, and the node model may be received from a first model repository maintained by the first cloud provider. A node model of a server provided by a second cloud provider may be in a second model-specific format that is different from the first model-specific format, and may be received from a second model repository maintained by the second cloud provider.

Received node models may represent different types of nodes and/or nodes provided by different providers. For example, the received node models may include a first node model corresponding to an application, in the cloud topology, provided by a first cloud provider, and a second node model corresponding to a server, in the cloud topology, provided by a second cloud provider. Received node models may include information about a respective corresponding node. Information regarding a node may include, for example, IF addresses, host information for the node, relationships with other nodes, user specifications for the node, how resources were provisioned for the node, events involving the node (e.g., an event log of what has occurred regarding the node since the node was provisioned/deployed), process definitions/engines (e.g., specifications from user-defined workflows), and node status (e.g., whether a node was successfully provisioned; idle/active/powered down state). In some implementations, information regarding a node may include actions that may be taken with respect to the node (e.g., de-provisioning the node or powering the node on/off). In some implementations, received node models may include general information about the topology that includes the corresponding nodes (e.g., who created the topology and when).

Instructions 208 may translate the respective model-specific format of each received node model into a generic format. As used herein, the term “generic format”, as used with respect to node models, should be understood to refer to a language and/or format that is cloud provider-independent and that may be used to convey information about a node. Generic-format node models of nodes may be in the same language/format even if the nodes are provided by different cloud providers. The language/format of a node model in a model-specific format may indicate which cloud provider provided the corresponding node, while the language/format of a generic-format node model may not indicate which cloud provider provided the corresponding node. Instructions 208 may identify information, that is in a model-specific format, about respective corresponding nodes and express the information in a generic format. The information in the generic format may be included in a generic-format node model of a node corresponding to a node model received from a model repository. Thus, instructions 208 may convert node models received from model repositories into generic-format node models.

Instructions 210 may send the generic-format node models to a topology visualizer. The topology visualizer may be implemented on a server or on a client device (e.g., a notebook computer, a desktop computer, a workstation, a tablet computing device, a mobile phone, a television, or an electronic book reader). The topology visualizer may generate, based on the generic-format node models, a visualization of the cloud topology. Sending generic-format node models rather than node models in model-specific formats to the topology visualizer may allow the topology visualizer to generate visualizations of topologies involving multiple cloud providers, without the topology visualizer having to recognize multiple languages/formats.

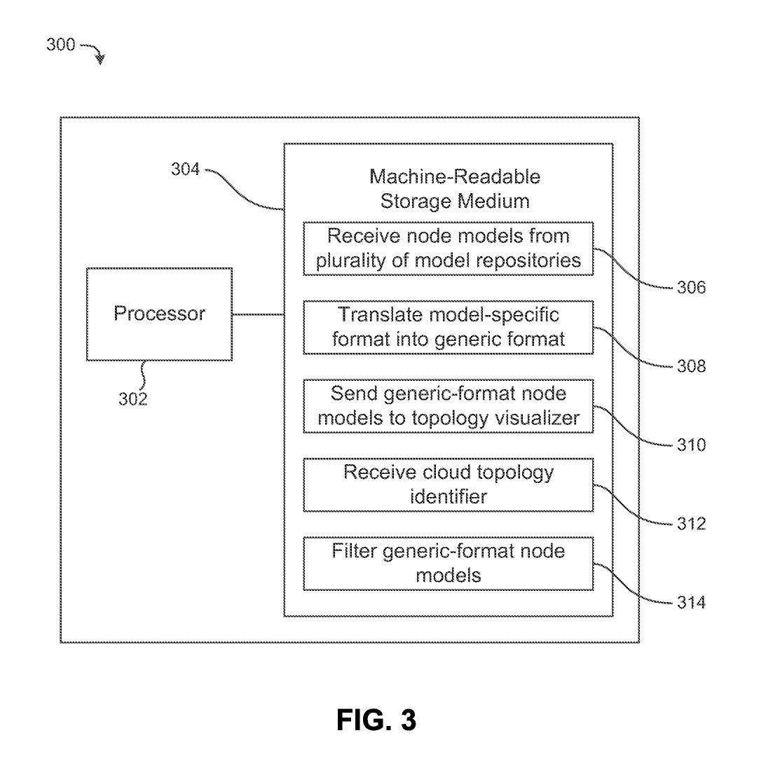

FIG. 3 is a block diagram of an example device 300 that includes a machine-readable storage medium encoded with instructions to enable filtering of data for generating a cloud topology visualization. In some implementations, device 300 may operate as and/or be part of a server, In FIG. 3, device 300 includes processor 302 and machine-readable storage medium 304.

As with processor 202 of FIG. 2, processor 302 may include a CPU, microprocessor (e.g., semiconductor-based microprocessor), and/or other hardware device suitable for retrieval and/or execution of instructions stored in machine-readable storage medium 304. Processor 302 may fetch, decode, and/or execute instructions 306, 308, 310, 312, and 314 to enable filtering of data for generating a cloud topology visualization, as described below. As an alternative or in addition to retrieving and/or executing instructions, processor 302 may include an electronic circuit comprising a number of electronic components for performing the functionality of instructions 306, 308, 310, 312, and/or 314.

As with machine-readable storage medium 204 of FIG. 2, machine-readable storage medium 304 may be any suitable physical storage device that stores executable instructions. Instructions 306, 308, and 310 on machine-readable storage medium 304 may be analogous to (e.g., have functions and/or components similar to) instructions 206, 208, and 210 on machine-readable storage medium 204. Instructions 312 may be executable to receive a cloud topology identifier. The received cloud topology identifier may be used to identify relevant node models in a plurality of model repositories. For example, the cloud topology identifier may be a service instance identifier that may be sent to various model repositories and used to identify/obtain information about nodes that are included in the topology to be visualized. The service instance identifier may include a binary or alphanumeric character string that identifies a deployed cloud instance/service. In some implementations, a service instance identifier may be input or selected using a user interface or a representational state transfer (REST) application programming interface (API).

Instructions 314 may filter generic-format node models before the generic-format node models are sent to a topology visualizer. In some implementations, instructions 314 may filter generic-format node models based on user permissions/roles. For example, confidential information may be deleted from the generic-format node models if the visualization generated based on the generic-format node models is requested by a user that does not have adequate clearance/permission to view such information. In some implementations, instructions 314 may customize generic-format node models according to user specifications.

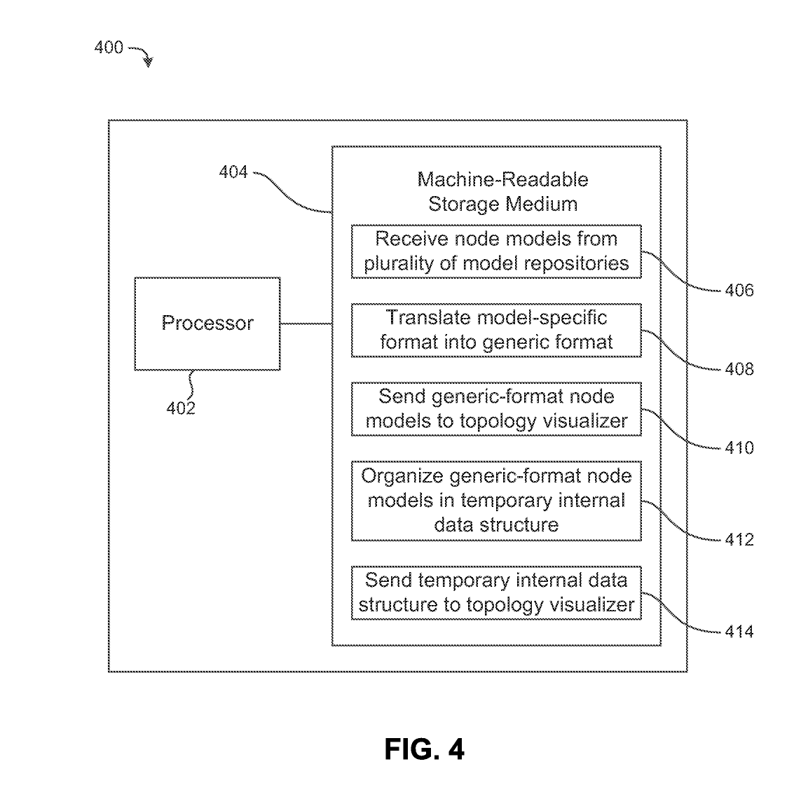

FIG. 4 is a block diagram of an example device 400 that includes a machine-readable storage medium encoded with instructions to send a temporary internal data structure to a topology visualizer. In some implementations, device 400 may operate as and/or be part of a server. In FIG. 4, device 400 includes processor 402 and machine-readable storage medium 404,

As with processor 202 of FIG. 2, processor 402 may include a CPU, microprocessor (e.g., semiconductor-based microprocessor), and/or other hardware device suitable for retrieval and/or execution of instructions stored in machine-readable storage medium 404. Processor 402 may fetch, decode, and/or execute instructions 406, 408, 410, 412, and 414. As an alternative or in addition to retrieving and/or executing instructions, processor 402 may include an electronic circuit comprising a number of electronic components for performing the functionality of instructions 406, 408, 410, 412, and/or 414.

As with machine-readable storage medium 204 of FIG. 2, machine-readable storage medium 404 may be any suitable physical storage device that stores executable instructions. Instructions 406, 408, and 410 on machine-readable storage medium 404 may be analogous to instructions 406, 408, and 410 on machine-readable storage medium 204. Instructions 412 may organize generic-format node models in a temporary internal data structure. For example, generic-format node models corresponding to the same node type may be grouped together in the temporary internal data structure. Different temporary internal data structures may be used for different topology visualizers.

Instructions 414 may send a temporary internal data structure to a topology visualizer. The topology visualizer may be implemented on a server or on a client device. The topology visualizer may generate, based on the generic-format node models in the temporary internal data structure, a visualization of the cloud topology.

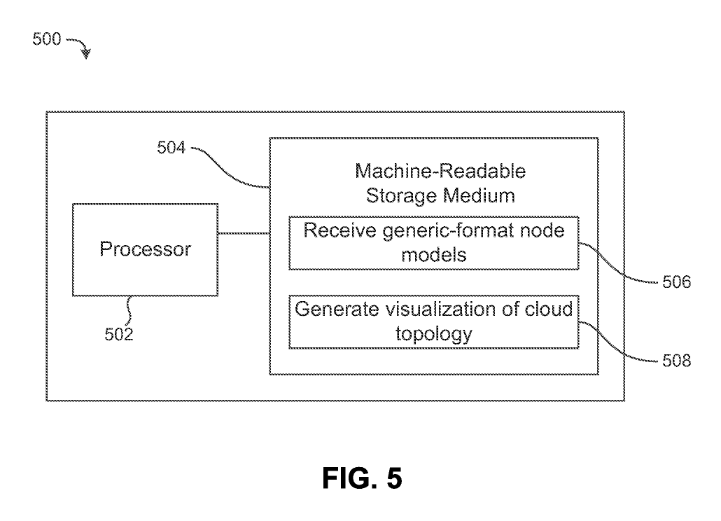

FIG. 5 is a block diagram of an example device 500 that includes a machine-readable storage medium encoded with instructions to generate a cloud topology visualization. In some implementations, device 500 may operate as and/or be part of a server. In some implementations, device 500 may be a user device, such as a notebook computer, a desktop computer, a workstation, a tablet computing device, a mobile phone, a television, or an electronic book reader. In FIG. 5, device 500 includes processor 502 and machine-readable storage medium 504.

As with processor 202 of FIG. 2, processor 502 may include a CPU, microprocessor (e.g., semiconductor-based microprocessor), and/or other hardware device suitable for retrieval and/or execution of instructions stored in machine-readable storage medium 504. Processor 502 may fetch, decode, and/or execute instructions 506 and 508. As an alternative or in addition to retrieving and/or executing instructions, processor 502 may include an electronic circuit comprising a number of electronic components for performing the functionality of instructions 506 and/or 508.

As with machine-readable storage medium 204 of FIG. 2, machine-readable storage medium 504 may be any suitable physical storage device that stores executable instructions. In some implementations, machine-readable storage medium 504 may include a non-transitory storage medium. As described in detail below, machine-readable storage medium 504 may be encoded with a set of executable instructions 506 and 508.

Instructions 506 may be executable to receive generic-format node models. The generic-format node models may correspond to nodes in the same cloud topology. The generic-format node models may be translated from node models that are each in a model-specific format associated with a respective cloud provider, as discussed above with respect to FIG. 2. In some implementations, the received generic-format node models may be in a temporary internal data structure, as discussed above with respect to FIG. 4.

Instructions 508 may generate, based on the generic-format node models, a visualization of the cloud topology. The visualization may include representations of nodes in the cloud topology and indications of relationships between the represented nodes. For example, instructions 508 may generate visualization 100 of FIG. 1. In some implementations, representations of nodes may be generated independently of how the respective represented nodes are implemented. For example, instructions 508 may generate a visualization in which nodes of different types are represented using the same symbol (e.g., the visualization may include two squares, one representing a server and one representing a network card). In some implementations, instructions 508 may generate a visualization of a topology that is not stable, and may automatically update the visualization periodically as changes occur. For example, instructions 508 may generate a visualization of a cloud topology that is being deployed, and may automatically update the visualization as various nodes are provisioned and deployed, allowing a user to view progress the cloud instance.

The visualization generated by instructions 508 may include representations of different types of nodes and/or nodes provided by different providers. For example, the representations of nodes may include a first representation corresponding to an application, in the cloud topology, provided by a first cloud provider, and a second representation corresponding to a server, in the cloud topology, provided by a second cloud provider. In some implementations, representations of nodes may indications of node status (e.g., whether a node was successfully provisioned; idle/active/powered down state) for respective represented nodes.

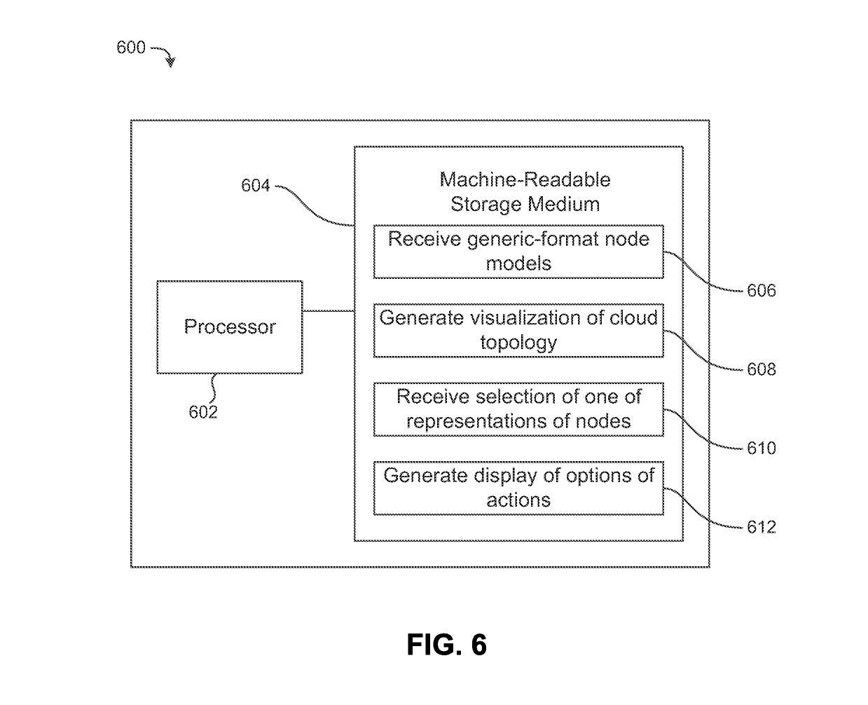

FIG. 6 is a block diagram of an example device 600 that includes a machine-readable storage medium encoded with instructions to generate a display of options for a cloud topology visualization. In some implementations, device 600 may operate as and/or be part of a server. In some implementations, device 600 may be a user device, such as a notebook computer, a desktop computer, a workstation, a tablet computing device, a mobile phone, a television, or an electronic book reader. In FIG. 6, device 600 includes processor 602 and machine-readable storage medium 604.

As with processor 502 of FIG. 5, processor 602 may include a CPU, microprocessor (e.g., semiconductor-based microprocessor), and/or other hardware device suitable for retrieval and/or execution of instructions stored in machine-readable storage medium 604. Processor 602 may fetch, decode, and/or execute instructions 606, 608, 610, and 612. As an alternative or in addition to retrieving and/or executing instructions, processor 602 may include an electronic circuit comprising a number of electronic components for performing the functionality of instructions 606, 608, 610, and/or 612.

As with machine-readable storage medium 504 of FIG. 5, machine-readable storage medium 604 may be any suitable physical storage device that stores executable instructions. Instructions 606 and 608 on machine-readable storage medium 604 may be analogous to instructions 506 and 508 on machine-readable storage medium 504. Instructions 608 may generate a visualization of a cloud topology, and the visualization may include representations of nodes in the cloud topology and indications of relationships between the represented nodes. Instructions 610 may be executable to receive a selection of one of the representations of nodes. For example, the cloud topology visualization may be displayed on a display screen of a user device, and a user may use a cursor or stylus to select one of the representations of nodes. Any other suitable method of selecting a representation of a node may be used. In some implementations, additional information about the node corresponding to the selected representation may be displayed (e.g., IP address, host name).

Instructions 612 may generate a display of options of actions to perform on a node corresponding to the selected representation. For example, a representation of a server may be selected, and instructions 612 may generate a display of options of actions that include powering down the server and putting the server in idle mode. Options of actions may vary based on the type of node corresponding to the selected representation. Node types may include, for example, servers, server groups, resource providers, networks, load balancers, network cards, and applications.

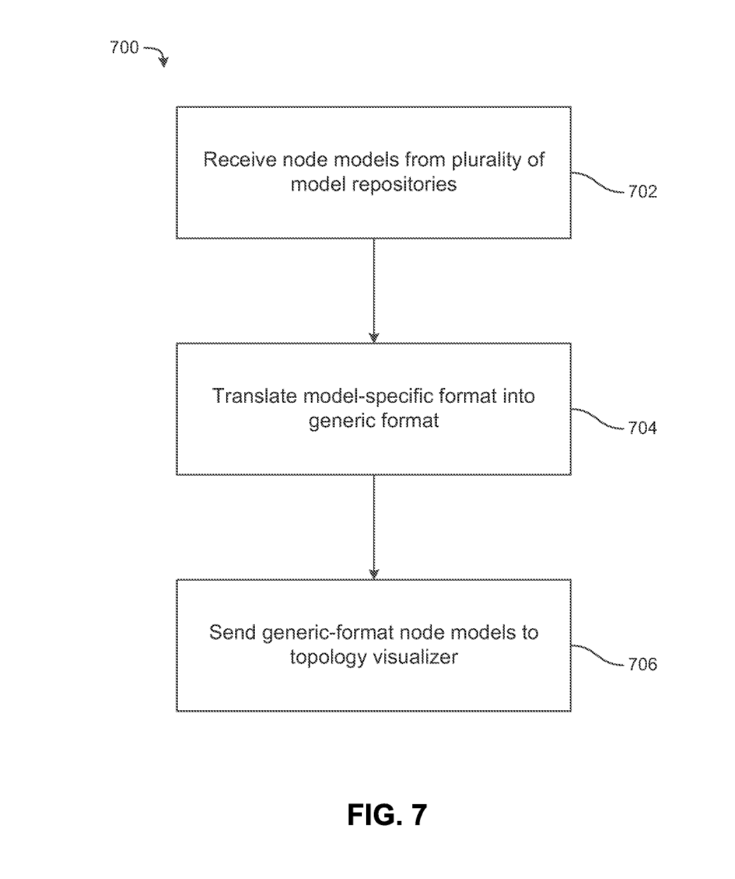

Methods related to visualizing cloud topologies are discussed with respect to FIGS. 7-9. FIG. 7 is a flowchart of an example method 700 for collecting data for a cloud topology visualization. Although execution of method 700 is described below with reference to processor 202 of FIG. 2, it should be understood that execution of method 700 may be performed by other suitable devices, such as processors 302 and 402 of FIGS. 3 and 4, respectively. Method 700 may be implemented in the form of executable instructions stored on a machine-readable storage medium and/or in the form of electronic circuitry.

Method 700 may start in block 702, where processor 202 may receive node models from a plurality of model repositories. The received node models may correspond to nodes in the same cloud topology. Each of the plurality of model repositories may be associated with a respective model-specific format and a respective cloud provider. Each of the received node models may be in a model-specific format associated with the respective model repository from which the node model was received.

Received node models may represent different types of nodes and/or nodes provided by different providers. For example, the received node models may include a first node model corresponding to an application, in the cloud topology, provided by a first cloud provider, and a second node model corresponding to a server, in the cloud topology, provided by a second cloud provider. Received node models may include information about a respective corresponding node, as discussed above with respect to FIG. 2, In some implementations, received node models may include general information about the topology that includes the corresponding nodes (e.g., who created the topology and when).

Next, in block 704, processor 202 may translate the respective model-specific format of each received node model into a generic format. For example, processor 202 may identify information, that is in a model-specific format, about respective corresponding nodes and express the information in a generic format. The information in the generic format may be included in a generic-format node model of a node corresponding to a node model received from a model repository. Thus, processor 202 may convert node models received from model repositories into generic-format node models.

Finally, in block 706, processor 202 may send the generic-format node models to a topology visualizer. The topology visualizer may be implemented on a server or on a client device. The topology visualizer may generate, based on the generic-format node models, a visualization of the cloud topology. Sending generic-format node models rather than node models in model-specific formats to the topology visualizer may allow the topology visualizer to generate visualizations of topologies involving multiple cloud providers, without the topology visualizer having to recognize multiple languages/formats. In some implementations, the generic format node models may be sent in a temporary internal data structure to the topology visualizer, as discussed above with respect to FIG. 4.

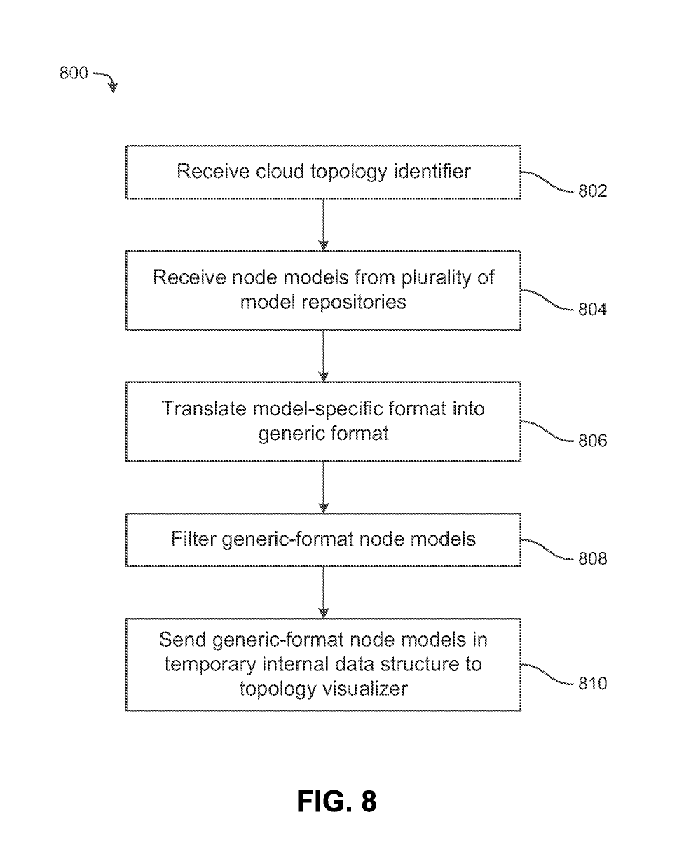

FIG. 8 is a flowchart of an example method 800 for filtering data for generating a cloud topology visualization. Although execution of method 800 is described below with reference to processor 302 of FIG. 3, it should be understood that execution of method 800 may be performed by other suitable devices, such as processors 202 and 402 of FIGS. 2 and 4, respectively. Some blocks of method 800 may be performed in parallel with and/or after method 700. Method 800 may be implemented in the form of executable instructions stored on a machine-readable storage medium and/or in the form of electronic circuitry.

Method 800 may start in block 802, where processor 302 may receive a cloud topology identifier. The received cloud topology identifier may be used to identify relevant node models in a plurality of model repositories, each of which may be associated with a respective model-specific format and a respective cloud provider. In some implementations, the cloud topology identifier may be a service instance identifier that may be sent to various model repositories and used to identify/obtain information about nodes that are included in the topology to be visualized. In some implementations, a service instance identifier may be input or selected using a user interface or a REST API.

In block 804, processor 302 may receive node models from the plurality of model repositories. The received node models may correspond to nodes in the same cloud topology. Each of the received node models may be in a model-specific format associated with the respective model repository from which the node model was received. The received node models may include information about a respective corresponding node, as discussed above with respect to FIG. 2.

Next, in block 806, processor 302 may translate the respective model-specific format of each received node model into a generic format. For example, processor 302 may identify information, that is in a model-specific format, about respective corresponding nodes and express the information in a generic format. The information in the generic format may be included in a generic-format node model of a node corresponding to a node model received from a model repository. Thus, processor 302 may convert node models received from model repositories into generic-format node models.

In block 808, processor 302 may filter the generic-format node models before the generic-format node models are sent to a topology visualizer. In some implementations, processor 302 may filter generic-format node models based on user permissions/roles. For example, processor 302 may delete confidential information from the generic-format node models if the visualization generated based on the generic-format node models is requested by a user that does not have adequate clearance/permission to view such information. In some implementations, processor 302 may customize generic-format node models according to user specifications.

Finally, in block 810, processor 302 may send the generic-format node models in a temporary internal data structure to a topology visualizer. In some implementations, processor 302 may group together, in the temporary internal data structure, generic-format node models corresponding to the same node type. Different temporary internal data structures may be used for different topology visualizers. A topology visualizer may be implemented on a server or on a client device, and may generate, based on the generic-format node models in the temporary internal data structure, a visualization of the cloud topology.

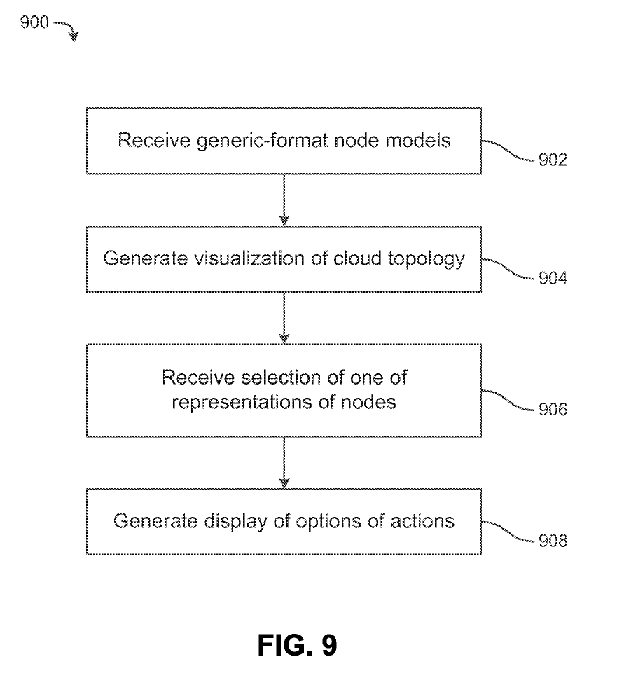

FIG. 9 is a flowchart of an example method 900 for generating a cloud topology visualization that includes options of actions. Although execution of method 900 is described below with reference to processor 602 of FIG. 6, it should be understood that execution of method 900 may be performed by other suitable devices, such as processor 502 of FIG. 5. Method 900 may be implemented in the form of executable instructions stored on a machine-readable storage medium and/or in the form of electronic circuitry.

Method 900 may start in block 902, where processor 602 may receive generic-format node models. The generic-format node models may correspond to nodes in the same cloud topology. The generic-format node models may be translated from node models that are each in a model-specific format associated with a respective cloud provider, as discussed above with respect to FIG. 2. In some implementations, the received generic-format node models may be in a temporary internal data structure, as discussed above with respect to FIG. 4.

Next, in block 904, processor 602 may generate, based on the generic-format node models, a visualization of the cloud topology. The visualization may include representations of nodes in the cloud topology and indications of relationships between the represented nodes. For example, processor 602 may generate visualization 100 of FIG. 1. In some implementations, processor 602 may generate representations of nodes independently of how the respective represented nodes are implemented, and/or may generate a visualization of a topology that is not stable, as discussed above with respect to FIG. 5.

The visualization generated by processor 602 may include representations of different types of nodes and/or nodes provided by different providers. For example, the representations of nodes may include a first representation corresponding to an application, in the cloud topology, provided by a first cloud provider, and a second representation corresponding to a server, in the cloud topology, provided by a second cloud provider. In some implementations, representations of nodes may indications of node status (e.g., whether a node was successfully provisioned; idle/active/powered down state) for respective represented nodes.

In block 906, processor 602 may receive a selection of one of the representations of nodes. For example, the cloud topology visualization generated in block 904 may be displayed on a display screen of a user device, and a user may use a cursor or stylus to select one of the representations of nodes. Any other suitable method of selecting a representation of a node may be used. In some implementations, additional information about the node corresponding to the selected representation may be displayed (e.g., IP address, host name).

Finally, in block 908, processor 602 may generate a display of options of actions to perform on a node corresponding to the selected representation. For example, a representation of a server may be selected, and processor 602 may generate a display of options of actions that include powering down the server and putting the server in idle mode. Options of actions may vary based on the type of node corresponding to the selected representation. Node types may include, for example, servers, server groups, resource providers, networks, load balancers, network cards, and applications.

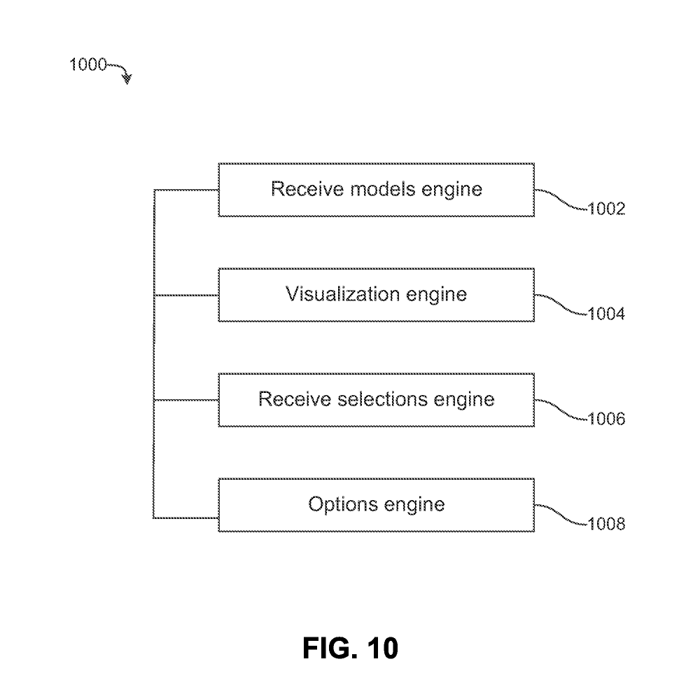

FIG. 10 is an example system 1000 for generating a cloud topology visualization that includes options of actions. In FIG. 10, system 1000 includes receive models engine 1002, visualization engine 1004, receive selections engine 1006, and options engine 1008. Receive models engine 1002 represents generally any combination of hardware and programming to receive generic-format node models. The generic-format node models may correspond to nodes in the same cloud topology. The generic-format node models may be translated from node models that are each in a model-specific format associated with a respective cloud provider, as discussed above with respect to FIG. 2. In some implementations, the received generic-format node models may be in a temporary internal data structure, as discussed above with respect to FIG. 4.

Visualization engine 1004 represents generally any combination of hardware and programming to generate, based on the generic-format node models, a visualization of the cloud topology. The visualization may include representations of nodes in the cloud topology and indications of relationships between the represented nodes. For example, visualization engine 1004 may generate visualization 100 of FIG. 1. In some implementations, visualization engine 1004 may generate representations of nodes independently of how the respective represented nodes are implemented, and/or may automatically update the visualization periodically as changes occur, as discussed above with respect to FIG. 5.

A visualization generated by visualization engine 1004 may include representations of different types of nodes and/or nodes provided by different providers. For example, the representations of nodes may include a first representation corresponding to an application, in the cloud topology, provided by a first cloud provider, and a second representation corresponding to a server, in the cloud topology, provided by a second cloud provider. In some implementations, representations of nodes may indications of node status (e.g., whether a node was successfully provisioned; idle/active/powered down state) for respective represented nodes.

Receive selections engine 1006 represents generally any combination of hardware and programming to receive a selection of one of the representations of nodes. For example, the cloud topology visualization may be displayed on a display screen of a user device, and a user may use a cursor or stylus to select one of the representations of nodes. Any other suitable method of selecting a representation of a node may be used. In some implementations, additional information about the node corresponding to the selected representation may be displayed (e.g., IP address, host name).

Options engine 1008 represents generally any combination of hardware and programming to generate a display of options of actions to perform on a node corresponding to the selected representation. For example, a representation of a server may be selected, and options engine 1008 may generate a display of options of actions that include powering down the server and putting the server in idle mode. Options of actions may vary based on the type of node corresponding to the selected representation. Node types may include, for example, servers, server groups, resource providers, networks, load balancers, network cards, and applications.

In foregoing discussion, various components were described as combinations of hardware and programming. Such components may be implemented in a number of fashions. The programming may be processor executable instructions stored on tangible memory media (e.g., a machine-readable storage medium) and the hardware may include a processor for executing those instructions. For example, machine-readable storage medium 504 (or 604) may be said to store program instructions that when executed by processor 502 (or 602) implement system 1000 of FIG. 10. In FIG. 6, instructions 606, 608, 610, and 612 stored in machine-readable storage may, when executed, cause the implementation of engines 1002, 1004, 1006, and 1008, respectively, of FIG. 10. A memory may be integrated in the same device as a processor, or may be separate but accessible to that device and the processor.

In some implementations, the program instructions may be part of an installation package that may be executed by a processor to implement system 1000. In such implementations, the memory may be a portable medium such as a CD, DVD, or flash drive or a memory maintained by a server from which the installation package may be downloaded and installed. In some implementations, the program instructions may be part of an application or applications already installed. In such implementations, the memory may include integrated memory such as a hard drive.

The foregoing disclosure describes cloud provider-independent node models for node topology visualizations. Example implementations described herein enable extensibility across various cloud providers and cloud deployment models for cloud topology visualizations.

We claim:

1. A method of collecting data for a cloud topology visualization, the method comprising:
receiving node models from a plurality of model repositories, wherein:
the received node models correspond to nodes in the same cloud topology;
each of the plurality of model repositories is associated with a respective model-specific format and a respective cloud provider; and
each of the received node models is in a model-specific format associated with the respective model repository from which the node model was received;
translating the respective model-specific format of each received node model into a generic format; and
sending the generic-format node models to a topology visualizer, wherein the topology visualizer generates, based on the generic-format node models, a visualization of the cloud topology.

2. The method of claim 1, further comprising receiving a cloud topology identifier, wherein the received cloud topology identifier is used to identify relevant node models in the plurality of model repositories.

3. The method of claim 1, wherein the generic-format node models are sent in a temporary internal data structure to the topology visualizer.

4. The method of claim 1, further comprising filtering the generic-format node models before the generic-format node models are sent to the topology visualizer.

5. The method of claim 1, wherein the received node models comprise:
a first node model corresponding to an application, in the cloud topology, provided by a first cloud provider; and
a second node model corresponding to a server, in the cloud topology, provided by a second cloud provider.

6. A machine-readable storage medium encoded with instructions executable by a processor for collecting data for a cloud topology visualization, the machine-readable storage medium comprising:
instructions to receive node models from a plurality of model repositories, wherein:
the received node models correspond to nodes in the same cloud topology;
each of the plurality of model repositories is associated with a respective model-specific format and a respective cloud provider; and
each of the received node models is in a model-specific format associated with the respective model repository from which the node model was received;
instructions to translate the respective model-specific format of each received node model into a generic format; and
instructions to send the generic-format node models to a topology visualizer, wherein the topology visualizer generates, based on the generic-format node models, a visualization of the cloud topology.

7. The machine-readable storage medium of claim 6, further comprising instructions to receive a cloud topology identifier, wherein the received cloud topology identifier is used to identify relevant node models in the plurality of model repositories.

8. The machine-readable storage medium of claim 6, further comprising:
instructions to organize the generic-format node models in a temporary internal data structure; and
instructions to send the temporary internal data structure to the topology visualizer.

9. The machine-readable storage medium of claim 6, further comprising instructions to filter the generic-format node models before the generic-format node models are sent to the topology visualizer.

10. The machine-readable storage medium of claim 6, wherein the received node models comprise:
a first node model corresponding to an application, in the cloud topology, provided by a first cloud provider; and
a second node model corresponding to a server, in the cloud topology, provided by a second cloud provider.

11. A system for generating a cloud topology visualization, the system comprising a receive models engine and a visualization engine, wherein:
the receive models engine is to receive generic-format node models;
the generic-format node models correspond to nodes in the same cloud topology;
the generic-format node models are translated from node models that are each in a model-specific format associated with a respective cloud provider; and
the visualization engine is to generate, based on the generic-format node models, a visualization of the cloud topology, wherein the visualization comprises representations of nodes in the cloud topology and indications of relationships between the represented nodes.

12. The system of claim 11, wherein representations of nodes are generated independently of how the respective represented nodes are implemented.

13. The system of claim 11, wherein the representations of nodes comprise:
a first representation corresponding to an application, in the cloud topology, provided by a first cloud provider; and
a second representation corresponding to a server, in the cloud topology, provided by a second cloud provider.

14. The system of dam 11, further comprising;
a receive selections engine to receive a selection of one of the representations of nodes; and
an options engine to generate a display of options of actions to perform on a node corresponding to the selected representation.

15. The system of claim 11, wherein the received generic-format node models are in a temporary internal data structure.
